(19) United States
(12) Patent Application Publication
(10) Pub. No.: US 2008/0082461 A1
(43) Pub. Date: Apr. 3, 2008

(54) Systems and methods for print accounting

(75) Inventor: Takayuki Kamata, Superior, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 11/541,093

(22) Filed: Sep. 29, 2006

(51) Int. Cl. G06F 17/00

(52) U.S. Cl. 705/408

(57) ABSTRACT

Systems and methods consistent with embodiments of the present invention provide for a method for print accounting. In some methods for print accounting, statistics related to print events are maintained and reported. The print accounting report may include a human-readable section and an encoded machine-readable section. In some embodiments, information contained in the human-readable section may be a subset of the information in the machine-readable section. The encoded machine-readable section may comprise a bar code or other encoding depending on the medium used for generating the report. In some embodiments, the machine-readable section may be encrypted prior to encoding. In some embodiments, the human-readable section may include an invoice based on printer usage statistics contained in the print accounting report. Information contained in the machine-readable section may be used to authenticate and verify information in human-readable section.

### BACKGROUND

1. Field of the Invention

The present invention relates to the field of print service management and in particular, to systems and methods for print accounting.

2. Description of Related Art

In most large commercial entities access to the modern and cost-effective technology is important and often provides a significant business advantage. Accordingly, many organizations may choose to lease non-core equipment to gain access to newer technology at affordable rates. Thus, an organization may choose to lease printers from a service provider rather than make an outright purchase. Such an arrangement allows for flexibility and permits quick and easy alterations to printing equipment based on business needs and/or forecasts. Commercial printing services may also choose to lease their printers to stay abreast of technological advancements, and for other financial and accounting reasons.

Lease rates on printers may depend in part on the usage of the printer, including the number of pages printed, ink, toner, cartridges, or other consumables used. In addition, the lessee or user may require that the printers maintain a specified mean time between failures (“MTBF”), or “up time,” and/or that the lessor or service provider maintain specified timely service commitments. In a leasing environment, the parties may have different perceptions about the usage of consumables or responsiveness of the service provider. In such situations, information provided by one party may not correspond to the assessment of the other party and confidence in any exchanged information may be low or non-existent. Thus, there is a need for an unbiased and trustworthy approach to maintaining and providing print accounting information, and automating and simplifying the reporting of such information.

### SUMMARY

In accordance with the present invention, systems and methods for maintaining and providing print accounting information are presented. The method performed comprises logging at least one of a plurality of events on a printing device; updating stored accounting information for an event triggered time period with the plurality of logged events; and generating a report for the time period comprising human-readable print accounting information and encoded print accounting information, using the updated stored accounting information. The event triggered time period may correspond to the time between specified printer events.

Events logged on the printing device may comprise one or more of the events of: printing of color pages; printing of monochrome pages; utilization of color ink; utilization of monochrome ink; utilization of print cartridges; error codes reported by printer components; errors requiring service calls; types of service performed during each service call; length of each service call; start of a time period; and end of a time period.

Updating stored accounting information may comprise one or more of the steps of: archiving stored accounting information for the time period; storing printer status at the end of the event-triggered time period; resetting and initializing stored accounting information; directly adding the logged event information to an appropriate location in stored accounting information, if the stored accounting information comprises raw event data; and performing mathematical operations to appropriately update stored accounting information, if the stored accounting information is derived from event information.

Stored accounting information for an event-triggered time period may comprise one or more of the: start of the event triggered time period; end of the event-triggered time period; total number of pages printed; total number of monochrome pages printed; total number of color pages printed; total numbers of pages printed, by size of printed page; average monochrome coverage; average color coverage; duration of error free operation; date of each failure; mean time between failures; average cost per page; total number of service calls; average length of service calls; and other event statistics.

Human-readable print accounting information may include a unique printer identification number and other print accounting information based on a user-specified reporting configuration. In some embodiments, the human-readable print accounting information may include printer status at the end of the event-triggered time period and an invoice for print services rendered over the event-triggered time period. Human-readable print accounting information may constitute a subset of the information contained in encoded print accounting information. Encoded print accounting information may be machine-readable. In some embodiments, encoded print accounting information may comprise a bar-code or a two dimensional bar-code, and may be encrypted prior to encoding. Encoded print accounting information may be used to authenticate information contained in the human-readable print accounting information

The methods may be performed in their entirety, or in part, by one or more devices such as a printer, a print server coupled to a printer, a print controller coupled to a printer, and/or a computer coupled to a printer. These and other embodiments are further explained below with respect to the following figures.

### BRIEF DESCRIPTION OF THE DRAWINGS

FIG. 1 shows a block diagram of an exemplary system for print accounting.

FIG. 2 shows a block diagram illustrating exemplary print accounting information maintained and/or provided to service providers and end-users.

FIG. 3 shows an exemplary diagram depicting exemplary print accounting information and an exemplary encoding of the information using a bar-code.

FIG. 4 shows a flowchart illustrating exemplary steps for print accounting configuration.

FIG. 5 depicts a flowchart describing an exemplary method for maintaining and providing print accounting information.

FIG. 6 shows a flowchart 600 for an exemplary method for configuring printers in a network to send accounting and/or status information to a central printer or computer for report generation.

### DETAILED DESCRIPTION

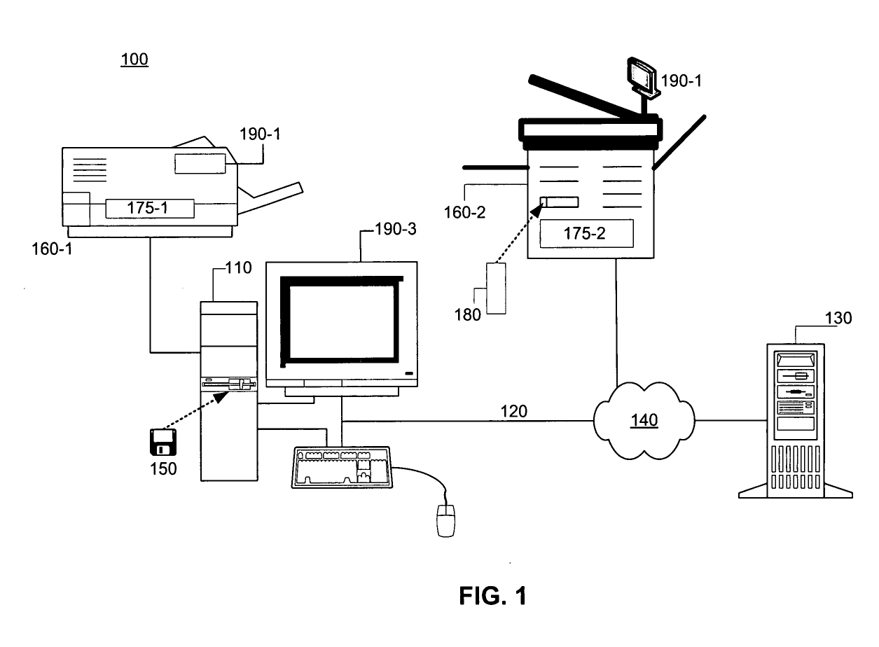

FIG. 1 shows an exemplary block diagram of a system for print accounting. A computer software application consistent with the present invention may be deployed on one or more networked computers, or printers, as shown in FIG. 1, that are connected through communication links that allow information to be exchanged using conventional communication protocols and/or data port interfaces.

As shown in FIG. 1, exemplary system 100 includes a computing device 110 and a server 130. Further, computing device 110 and server 130 may communicate over a connection 120, which may pass through network 140, which in one case could be the Internet. Computing device 110 may be a computer workstation, desktop computer, laptop computer, or any other computing device capable of being used in a networked environment. Server 130 may be a platform capable of connecting to computing device 110 and other devices too (not shown). Computing device 110 and server 120 may be capable of executing software (not shown) that allows the control and configuration of printing devices 160, such as exemplary printing devices 160-1 and 160-2.

Computing device 110 may contain a removable media drive 150. Removable media drive 150 may include, for example, 3.5 inch floppy drives, CD-ROM drives, DVD ROM drives, CD±RW or DVD±RW drives, USB flash drives, and/or any other removable media drives consistent with embodiments of the present invention. Portions of software applications may reside on removable media and be read and executed by computing device 110 using removable media drive 150. In some embodiments, results or reports generated by applications may also be stored on removable media.

Connection 120 couples computing device 110, server 130, and printer 160-2 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB, SCSI, FIREWIRE, and/or BNC ports for transmission of data through the appropriate connection 120. The communication links could be wireless links or wired links or any combination that allows communication between computing device 110, server 130, and printer 160-2.

Network 140 could include a Local Area Network (LAN), a Wide Area Network (WAN), or the Internet. In some embodiments consistent with the present invention, information sent over network 140 may be encrypted to ensure the security of the data being transmitted.

Exemplary printing device 160-2, may be a network printer, and can be connected to network 140 through connection 120. In some embodiments, a printing device, such as exemplary printing device 160-1, may be a local or dedicated printer and connected directly to computing device 110 and/or server 120. System 100 may include multiple printing devices and other peripherals (not shown), according to embodiments of the invention. Printing devices 160 may be controlled by hardware, firmware, or software, or some combination thereof. Printing devices 160 may include one or more print controller boards 175, such as exemplary print controllers 175-1 and 175-2, which may control the operation of printing devices 160. Printing devices 160 may be controlled by firmware or software resident on memory devices in print controllers 175. In general, print controllers 175 may internal or external print devices 160. In some embodiments, printing devices 160 may also be controlled in part by software, including print servers, or other software, running on computing device 110 or server 120.

Printing devices, such as exemplary printing device 160-2, may also have ports for the connection of flash drives, USB drives, or other storage devices 180, as shown in FIG. 1. In some embodiments, results or reports generated by an application executing on printer 175-2 may be stored on storage device 180. Printing devices, such as exemplary printing device 160-2, may also include consoles 190 such as consoles 190-1 and 190-2, or other interfaces to allow configuration options to be set and other messages to be displayed. In some embodiments, one or more configuration options may be set using a display or user-interface on a monitor for a computer coupled to printing devices 160. For example, user interfaces to set one or more configuration options on printing device 160-1 may be displayed on monitor 190-3, which is coupled to computer 110. A user interface to set configuration options on printer 160-2 may also be displayed on monitor 190-3, using software running on server 130.

In some embodiments, configuration parameters pertaining to printing device 170 may be user-configurable. For example, the print resolution, document sizes, color options, and other configuration parameters may be user-configurable. A user may also be able to specify input trays and the use of automatic document feeders to allow batch processing of documents. Users may also be able to log into a printing device 160 to perform administrative functions such as to enable software or firmware on printing device 160 to perform various functions. In some embodiments, the log in process may require a password or other user-authentication mechanism.

A computer software application consistent with the present invention may be deployed on any of the exemplary computers, or printers as shown in FIG. 1. For example, computing device 110 could execute software that may control and/or monitor the operation of printer 160-1. An independent application may also execute concurrently on printer 160-2 based on its configuration. In another example, an application resident on print controller 175-1 could be configured using computer 110 but execute on printing device 160-1. In general, applications may execute in whole or in part on one or more computers, print controllers, or printers in the system.

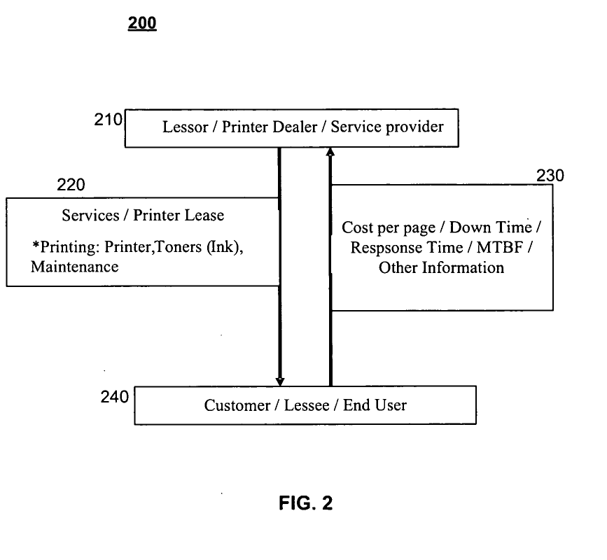

FIG. 2 shows a block diagram illustrating exemplary print accounting information maintained and/or provided to service providers and users. As shown in FIG. 2, lessor, printer dealer, or service provider 210 may provide services 220 to lessee, customer, or end user 240 including the lease of printing devices 160. Services 220 provided by service provider 210 to end user 240 may also include one or more of routine maintenance, ink and/or toner replacement, and other services described in the service agreement. Print accounting information 230, such as number of pages printed, down time, MTBF, service intervals, etc. are useful to both service provider 210 and end-user 220. Typically, end-user 220 may be interested only in items in print accounting information 230 that directly impact the cost of services provided. For example, end-user 220 may be interested in the number of total pages printed, ratio of color to monochrome (or black and white) pages, cost per page, etc. On the other hand, service provider 210 may wish to keep track of several additional information items, such as MTBF, length and frequency of service requests, error codes generated by printers, etc. to fine-tune service provider's business model, set rates and lease terms, determine the relative quality of different printer models and brands, or to keep track of service-related issues. In some instances, service provider 210 may not want to share some of the available print accounting information with end-user 220.

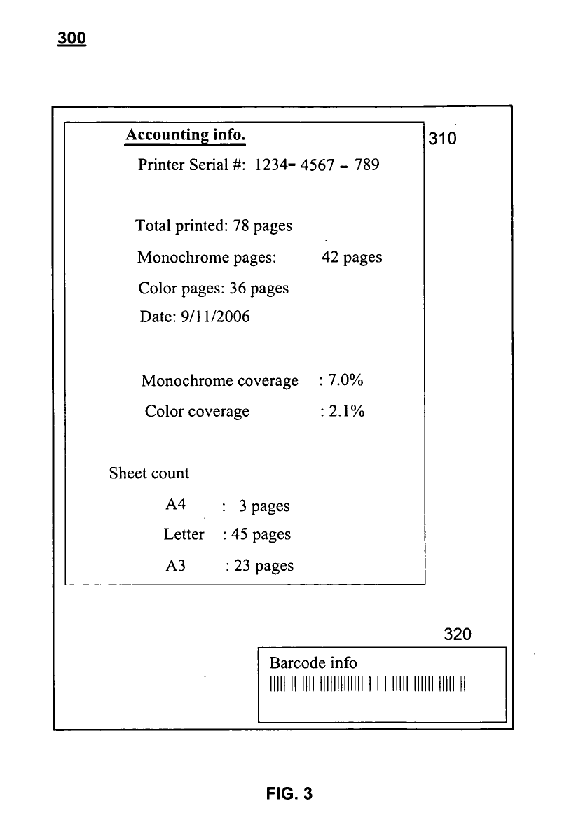

FIG. 3 shows an exemplary diagram depicting exemplary print accounting information 310 and an exemplary encoding 320 of print accounting information using a bar-code. As shown in FIG. 3, print accounting information may be printed by printing device 160 on a sheet of paper. In some embodiments, print accounting information 310 may also be stored by printing device on storage device 180. Print accounting information may also be stored in non-volatile memory on printing device 160. In some embodiments, the non-volatile memory may reside on print controllers 175, or on a storage device on a computer coupled to printing devices 160. For example, print accounting information for printer 160-1 may be stored on storage devices coupled to computer 110. Print accounting information 310 may include a printer serial number or identification number to uniquely identify each printer and other additional information such as the number of pages printed, reporting period, date of report, number of color pages, and other statistical data that may be requested by end-user 220, or that service-provider 210 may choose to provide.

It should be noted that the use of bar-codes to represent encoded print accounting information 320 is exemplary only and other representational schemes for encoding information may be used. In some embodiments, the bar-codes may be two-dimensional bar codes. Although, encoded print accounting information 320 is shown as being printed on a bottom right of the page, in practice such information may be printed anywhere on the page or even on a separate page. In some instances, encoded print accounting information 320 may be a simple encoding of print accounting information 310. In other instances, encoded print accounting information 320 may include additional information, including details and statistical information not present in print accounting information 310. In some embodiments, print accounting information may be encrypted prior to encoding. In general, information contained in print accounting information 310 may constitute a subset of the information contained in encoded print accounting information 320.

The encoding of print accounting information can help prevent and/or detect alterations to print accounting information 310 or encoded print accounting information 320. In some embodiments, encoded print accounting information 320 may include check-sums, cyclic redundancy checks (“CRC”), error correction and coding (“ECC”), or other mechanisms to detect and/or correct errors and alterations. End users 220 may print and track accounting information at any time by using menus for printing devices 160. In some embodiments, the menus may be displayed on display devices 190, such as screen 190-1. In general, the type of encoding scheme used may depend on the type of media being used to generate report 300 and on the capabilities available on printing devices 160, print controllers 175, and/or computers coupled to printing devices 160.

In some instances, printed print accounting statement 300 may be mailed to service provider 210. Service provider 210 may scan, decipher, and authenticate the encoded information, which may then be used to generate accounting reports, invoices for services provided etc. In some instances, print accounting information 310 may include an invoice for services provided and a payment mailing address so that a payment for services provided may be mailed directly to service provider 210 by end user 220. Encoded print accounting information 320 on the printed print accounting statement 300 may be read and decoded by service provider 210 to verify the accuracy and authenticity of print accounting information 310, which includes the invoice.

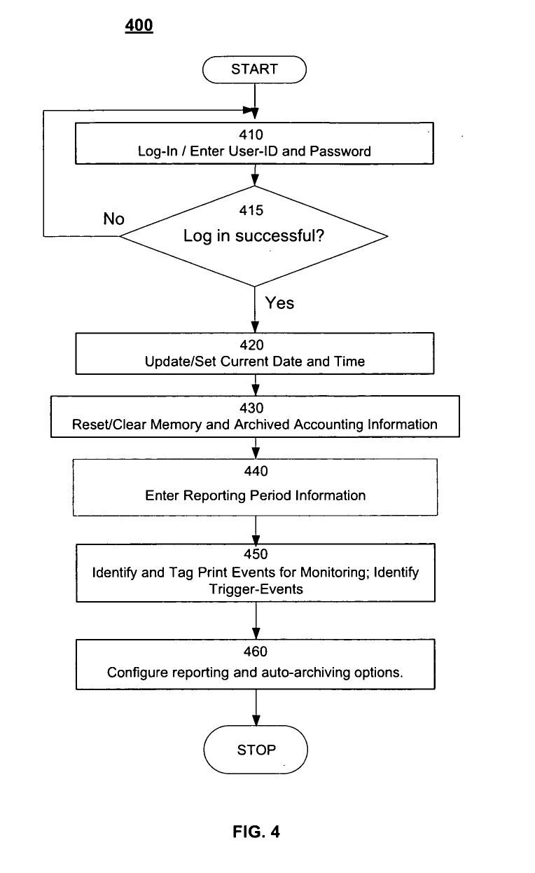

FIG. 4 shows a flowchart illustrating steps in an exemplary method 400 for configuring printing devices 160 to print accounting information. In some embodiments, an algorithm for configuring print devices 160 to print accounting information 300 may be executed on printing devices 160. User-interfaces and/or menus to facilitate print accounting information configuration may be displayed on printing devices 160, consoles 190, or on monitors coupled computing device 110 or server 130. In step 410, a user may be asked to log in as an administrator with a login-id and password. The use of a login-id and password can help ensure that only authorized users, such as administrators, can change settings and configure the printing devices 160. The login-id and password are validated in step 415. If the login process is unsuccessful, the user may be returned to step 410. In some embodiments, login-id lockout schemes may be implemented if there are repeated failed attempts to log in with incorrect login-ids or passwords.

If the login process is successful, then in step 420, the administrator may be asked to enter, verify, or update date and time settings. Next, in step 430, the administrator may be provided with an option to reset or clear memory and archived data and configuration settings. For example, data relevant to a prior lessor or end-user of the printer may be cleared, or outdated archived data may be deleted in order to free memory. In step 440, the administrator may be asked to enter data about the frequency of the reporting period, including start and end dates. For example, a reporting period may be monthly, and start on the 16^{th} of each month. Other reporting periods may be specified by end-user 220 or set by service provider 210 according to embodiments of the invention.

In step 450, the administrator may select from several events that may be tagged for reporting. For example, events such as the number of pages printed, number of service calls, numbers of monochrome and color pages, coverage of each page etc. may be identified as reportable events. Identification of reportable events permits printing devices to track and store information about the identified events as they occur. Certain events may also be configured to be trigger events. When a trigger-event occurs, its occurrence and other statistics may need to be reported. A trigger event could correspond to a certain number of pages having been printed, a specific error code, a failure, or other situations identified by end-user 220 or service-provider 210. In some embodiments, a default reporting profile may be provided that identifies commonly reported events and the administrator can edit the default reporting profile as desired. In general, the types of reporting options provided may depend on hardware, software, or firmware associated with printing devices 160.

In step 460, the administrator may be able to configure reporting options such as the frequency of reports, items in print accounting information 310, items in encoded print accounting information 320, type of encoding, whether an invoice is to be automatically generated as part of print accounting information 310, per page costs, mailing addresses, etc. In general, reporting options provided may depend on the hardware, software, or firmware associated with printing devices 160. The administrator may also be able to configure auto-archiving options, such as the frequency with which data stored in memory is backed up to storage, the length of time an archive should be kept in memory etc. In some embodiments, a default profile may be provided for reporting and archiving options and the administrator may be able to edit the profile as desired. Once the administrator is satisfied that printing devices have been appropriately configured the configuration may be saved prior to exiting. In some embodiments, a menu or GUI may be provided on a central computer or printing device to enable the configuration of multiple printers from a single location. In some embodiments, a default profile may be maintained at the location that may be applied to all printers being configured. In some embodiments, the default profile may be model specific based on features available with various printer models.

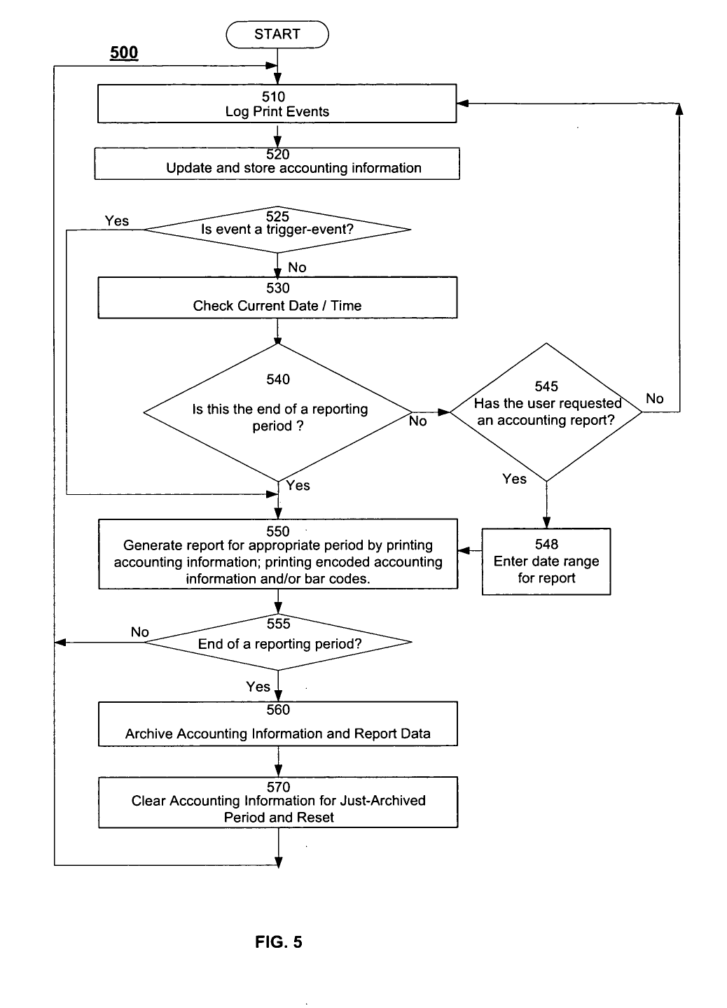

FIG. 5 depicts a flowchart describing an exemplary method 500 for maintaining and providing accounting information according to embodiments of the invention. In step 510, reportable events are logged as they occur. In step 520, the reportable events may be used to update stored accounting information.

Event information may be added directly to appropriate locations in stored accounting information, if raw event information is being stored. Event information may be operated upon mathematically prior to being used to update accounting information, if accounting information is statistical or derived from raw event information. For example, mechanical breakdowns or error codes may be logged individually, whereas paper counts may be stored cumulatively. As another example, start and end dates may be stored both as individual events and as accounting information and may be printed on print accounting report 300. In step 525, the event is checked to determine if the event is a trigger-event. If the event is determined to be a trigger-event, then the algorithm proceeds to step 550. In step 530, the current date and time are logged. In step 540, the current date and time is compared with reporting period information.

In step 550, a report is generated. A report may be generated in step 550, if it is the end of a reporting period, if a trigger-event has occurred, or if the user chooses to generate a report. In some embodiments, the report may be printed on physical media and take the form of print accounting report 300 and include print accounting information 310 and encoded print accounting information 320. In general, the report may take any form as specified by report configuration options. For example, the report configuration options set in step 460 may be used to generate an appropriate report. A report may also include an invoice and encoded print accounting information, which may encode information contained in the invoice along with other information. Encoded print accounting information may take the form of a bar code. In some embodiments, a print accounting report may be generated electronically and stored on storage media on printing devices 160, storage devices 180, removable media 150, or other storage on computer 110 or server 130. In some embodiments, print accounting report can be electronically transmitted to service provider 210.

If it is not the end of a reporting period, then in step 545, user 220 may be given an option to generate a report to track usage statistics. If user 220 chooses to generate a report, then in step 548, user 220 may be asked to input reporting period dates after which a report may be generated in step 550. If the user chooses not to generate a report, then the algorithm returns to step 510, where the next event is logged.

In step 555, the algorithm may check to see if it is the end of a reporting period so that information for the current reporting period may be archived in step 560. In step 570, the algorithm may clear memory and variables associated with the just-archived reporting period and perform initialization and reset operations prior to returning to step 510, where information can be logged for the new reporting period.

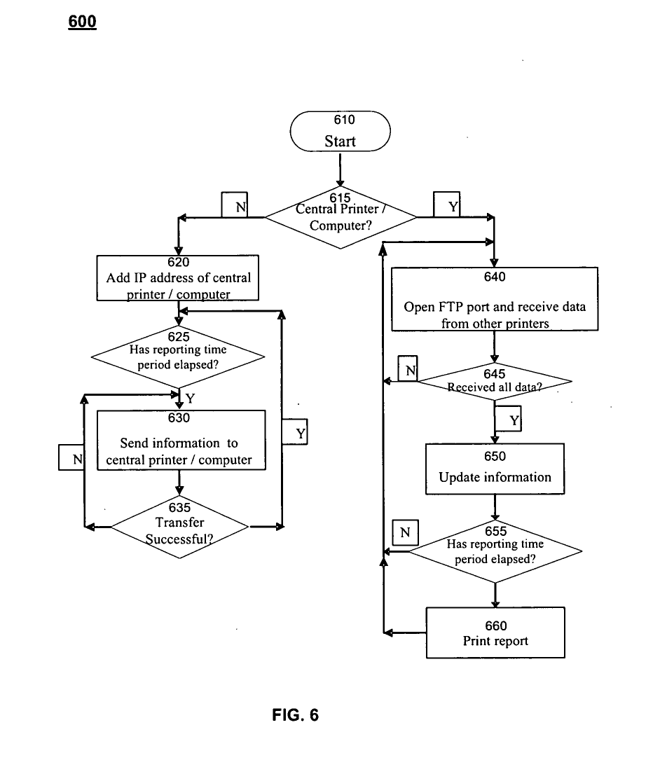

FIG. 6 shows a flowchart 600 for an exemplary method for configuring printers in a network to send accounting and/or status information to a central printer or computer for report generation. The exemplary method illustrated by flowchart 600 allows reports, such as exemplary report 300, generated by individual printers in a network to be electronically transmitted to a central computer or printer for printing. For example, each printer may transfer a Portable Document Format (PDF), PostScript, or other file to a specified location on central computer or printer. In some embodiments, central computer could be computer 110 or server 130 and any of printing devices 160 in network 140 could be configured as a central printer. The algorithm commences in step 610. In step 615, a determination is made whether each printing device 160 in a network has been configured as a central printer, or whether the device is a central computer. In some embodiments, a printing device could be both a reporting printer and a central printer. In other embodiments, central printer may not be a reporting printer itself and may only print reports 300 for individual reporting printers. In some embodiments, the method in flowchart 600 may be performed concurrently by printers 160 in conjunction with the method in flowchart 500. In some embodiments, the internal clocks of all printers may be synchronized, or a common LAN or network clock used to synchronize the operations of all the printers.

If a device determines that it is a central computer or printer then, in step 640, it opens a file transfer protocol (“ftp”) port where reports by other printing devices in the network may be transferred. In some embodiments, a printer may be configured as a central printer or an individual non-central printer during report configuration step 460. In general, any agreed upon protocol may be used to transfer the report to a specified location on central printer or computer. In step 645, central computer or printer may check to ensure that it has received a report from all printers on a network. If not, it may request that the data be resent, or take other corrective action.

In some embodiments, a list of reporting printers may be used to determine all reporting printing devices on a network. The list of reporting printers may be maintained and updated as reporting printers are added and deleted from a network. In some embodiments, a printing device being added to a network may automatically query other devices on the network to obtain the address and port information of a central printer or computer. In addition, the newly added printer may also register with the central computer or printer so that the central computer or printer can update its list of reporting printers with the newly added printer. In some embodiments, a central computer or printer may query printing devices on a network at some predetermined intervals in order to update its list of reporting print devices.

In step 650, information stored by central computer or printer may be updated with report information received from other reporting printers. In step 655, the central printer or computer determines if the cumulative reporting period has elapsed. If the reporting period has ended, a cumulative report for that period with information about all reporting printers may be generated. In general, reports 300 may be sent to central printer or computer by individual printers periodically, or at the end of a reporting period. In some embodiments, the reporting period for individual non-central printers may be set to be slightly shorter than the reporting period for a central computer or printer so that all printer reports may be received by the central computer or printer before a final cumulative report with information about all the individual reporting printers is generated by the central computer/printer. Central printer may then archive reported information and return to step 640, to collect information for the next reporting period.

If the printer is determined not to be a central printer then the address and port information of central printer or computer may be added to the printer, in step 620. In some embodiments, address/port information about central computer or printer to which reporting data is to be sent may be added during report configuration step 460.

In step 625, the printer determines if the reporting period has elapsed. If the reporting period has ended, a report with information for the period may be generated and sent to central computer in step 630. In step 635, the status of the report transmission is checked. If the transfer is successful the reporting printer may archive information for the period, begin the next reporting period, and return to step 625. If the information transfer is unsuccessful, then it is retried until the information has been successfully transferred.

Note that methods consistent with embodiments of the invention may conveniently be implemented using program modules, hardware modules, or a combination of program and hardware modules. Such modules, when executed, may perform the steps and features disclosed herein, including those disclosed with reference to the exemplary flow charts shown in the figures. The operations, stages, and procedures described above and illustrated in the accompanying drawings are sufficiently disclosed to permit one of ordinary skill in the art to practice the invention. Moreover, there are many computers, printing devices, and operating systems that may be used in practicing embodiments of the instant invention and, therefore, no specific detailed programs could be provided that would be applicable to each of these different systems. Each user of a particular environment will be aware of the language, hardware, and tools that are most useful for that user's needs and purposes.

The above-noted features and aspects of the present invention may be implemented in various environments. Such environments and related applications may be specially constructed for performing the various processes and operations of the invention, or they may include a general-purpose computer or a multi-function printing device that includes a local computing platform selectively activated or reconfigured by program code to provide appropriate functionality. The processes disclosed herein are not inherently related to any printing device, particular computer or other apparatus, and aspects of these processes may be implemented by any suitable combination of hardware, software, and/or firmware. For example, various general-purpose machines may be used with programs written in accordance with teachings of the invention, or it may be more convenient to reconfigure or construct a specialized printing apparatus or system to perform the required methods and techniques.

Embodiments of the present invention also relate to compute-readable media that include program instructions or program code for performing various computer-implemented operations based on the methods and processes of embodiments of the invention. The program instructions may be those specially designed and constructed for the purposes of the invention, or they may be of the kind well known and available to those having skill in the computer arts. Examples of program instructions include, for example, machine code, such as produced by a compiler, and files containing a high-level code that can be executed by the computer using an interpreter.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims. As such, the invention is limited only by the following claims.

1. A method comprising:
logging at least one of a plurality of events on a printing device;
updating stored accounting information for an event-triggered time period with the at least one of a plurality of logged events; and
generating a report for the event-triggered time period using the updated stored accounting information, wherein the report comprises human-readable print accounting information and encoded print accounting information.

2. The method of claim 1, wherein the event-triggered time period corresponds to the time between specified events.

3. The method of claim 1, wherein the at least one of a plurality of events logged on the printing device comprises one or more of the events of:
printing of color pages;
printing of monochrome pages;
utilization of color ink;
utilization of monochrome ink;
utilization of print cartridges;
error codes reported by printer components;
errors requiring service calls;
types of service performed during each service call;
length of each service call;
start of an event-triggered time period; and
end of an event-triggered time period.

4. The method of claim 1, wherein updating stored accounting information comprises one or more of the steps of:
archiving stored accounting information for the event-triggered time period;
storing printer status at the end of the event-triggered time period;
resetting and initializing stored accounting information;
directly adding the logged event information to an appropriate location in stored accounting information, if the stored accounting information comprises raw event data; and
performing mathematical operations to appropriately update stored accounting information, if the stored accounting information is derived from event information.

5. The method of claim 1, wherein stored accounting information for an event-triggered time period comprises one or more of:
start of the event-triggered time period;
end of the event-triggered time period;
total number of pages printed;
total number of monochrome pages printed;
total number of color pages printed;
total numbers of pages printed, by size of printed page;
average monochrome coverage;
average color coverage;
duration of error free operation;
date of each failure;
mean time between failures;
average cost per page;
total number of service calls; and
average length of service calls.

6. The method of claim 1, wherein the human-readable print accounting information includes a unique printer identification number and other print accounting information based on a user-specified reporting configuration.

7. The method of claim 1, wherein the human-readable print accounting information comprises one or more of printer status information at the end of the event-triggered time period and an invoice for print services rendered over the event-triggered time period.

8. The method of claim 1, wherein the human-readable print accounting information is a subset of the information contained in encoded print accounting information.

9. The method of claim 1, wherein the encoded print accounting information is machine-readable.

10. The method of claim 9, wherein the machine-readable encoded print accounting information comprises a bar-code.

11. The method of claim 9, wherein the machine-readable encoded print accounting information comprises a two dimensional bar-code.

12. The method of claim 1, wherein the encoded print accounting information is encrypted prior to encoding.

13. The method of claim 1, wherein the encoded print accounting information is used to authenticate information contained in the human-readable print accounting information.

14. The method of claim 1, wherein the method is performed by one or more of:
a printer;
a print server;
a print controller coupled to a printer; and
a computer coupled to a printer.

15. A computer-readable medium that stores instructions, which when executed by a processor perform steps in a method for print accounting, the steps comprising:
logging at least one of a plurality of events on a printing device;
updating stored accounting information for an event-triggered time period with the at least one of a plurality of logged events; and
generating a report for the event-triggered time period using the updated stored accounting information, wherein the report comprises human-readable print accounting information and encoded print accounting information.

16. The method of claim 15, wherein updating stored accounting information comprises one or more of the steps of:
archiving stored accounting information for the event-triggered time period;
storing printer status at the end of the event-triggered time period;
resetting and initializing stored accounting information;
directly adding the logged event information to an appropriate location in stored accounting information, if the stored accounting information comprises raw event data; and
performing mathematical operations to appropriately update stored accounting information, if the stored accounting information is derived from event information.

17. The method of claim 15, wherein the human-readable print accounting information is a subset of the information contained in encoded print accounting information.

18. The method of claim 15, wherein the encoded print accounting information is machine-readable.

19. The method of claim 15, wherein the encoded print accounting information may be used to authenticate information contained in the human-readable print accounting information.

20. A system for print accounting comprising:
means for logging at least one of a plurality of events on a printing device;
means for updating stored accounting information for an event-triggered time period with the at least one of a plurality of logged events; and
means for generating a report for the event-triggered time period using the updated stored accounting information, wherein the report comprises human-readable print accounting information and encoded print accounting information.

21. The system of claim 20, wherein updating stored accounting information comprises one or more of the steps of:
means for archiving stored accounting information for the event-triggered time period;
means for storing printer status at the end of the event-triggered time period;
means for resetting and initializing stored accounting information;
means for directly adding the logged event information to an appropriate location in stored accounting information, if the stored accounting information comprises raw event data; and
means for performing mathematical operations to appropriately update stored accounting information, if the stored accounting information is derived from event information.

22. The method of claim 20, wherein the human-readable print accounting information is a subset of the information contained in encoded print accounting information.

23. The method of claim 20, wherein the encoded print accounting information is machine-readable.

24. The method of claim 20, wherein the encoded print accounting information may be used to authenticate information contained in the human-readable print accounting information.
